(19) United States
(12) Patent Application Publication
(10) Pub. No.: US 2026/0097572 A1
(43) Pub. Date: Apr. 9, 2026

(54) APPARATUS FOR PRODUCING FRUSTOCONICAL BARREL BODIES MADE OF PAPER AND METHOD

(71) Applicant: IMBALLAGGI INVERNIZZI S.P.A., Bergamo (IT)

(72) Inventors: Enrico INVERNIZZI, Bergamo (IT); Francesco INVERNIZZI, Bergamo (IT)

(21) Appl. No.: 19/346,734

(22) Filed: Oct. 1, 2025

(30) Foreign Application Priority Data
Oct. 3, 2024 (IT) 102024000021948

(51) Int. Cl. B31C 7/02

(52) U.S. Cl. CPC B31C 7/02

(57) ABSTRACT

An apparatus for producing a frustoconical barrel body made of paper has a feeding station having a pulling assembly for unwinding paper at a preset unwinding speed, a substantially frustoconical drum operable in rotation around a rotation axis, and a fly cutting device upstream of the substantially frustoconical, suitable for cutting the paper into paper sheets without stopping or reducing the preset unwinding speed. A conveyor device allows sliding of the paper sheets from the feeding station towards the substantially frustoconical drum. A method for making the frustoconical barrel body by the apparatus is provided.

### CROSS-REFERENCE TO RELATED APPLICATION

This application claims priority to Italian Patent Application No. 102024000021948 filed Oct. 3, 2024, the entire contents of which is hereby incorporated in its entirety by reference.

### FIELD OF THE INVENTION

The present invention relates to an apparatus for producing frustoconical barrels made of paper, preferably kraft fibre, for example for industrial storage.

### BACKGROUND OF THE INVENTION

As it is known, several types of containers are currently commercially available, consisting of a plurality of kraft fibre sheets superposed and glued to one another so as to make the body of a barrel having a reduced weight and a robust structure. Such containers or barrels, widely used in numerous industrial applications, exist in various shapes, mainly cylindrical or frustoconical.

Some known apparatuses for the making of these containers require a considerable amount of manual labour, to correctly arrange the paper sheets on a forming drum.

The most widespread equipment allows the making of the barrel body by winding, around a frustoconical mandrel, two strips of reduced width, according to cylindrical helices arranged side by side, so as to partially overlap the two strips along the development of the two helical arrangements. This process, as is evident, requires a large amount of material due to the relatively high overlap of the paper strips to implement an adequate mechanical connection of the container.

Moreover, the barrels thus obtained by means of such equipment certainly have a poor aesthetic finishing, since, unless they are subsequently coated, they show on the surface the cardboard helices.

Document EP0340178B1 describes a machine for producing barrel bodies made of fibre having frustoconical conformation, which allows the achievement of frustoconical barrel bodies from the superposition of a series of pre-cut cardboard sheets and coated on one face with adhesive film, which are then rotated successively, one on top of the other, around a frustoconical mandrel.

Inconveniently, such a machine, while offering advantages compared with the version that provides for the winding of cardboard helices, has a series of limits.

Disadvantageously, in fact, such a machine allows a low productivity, since the steps of cutting and subsequent transporting of the cut sheets towards the mandrel require a slow processing and downtimes of the feeding step, i.e., the processing is not continuous.

Moreover, according to a further drawback, the machine described in said document requires the continuous aid of an operator for the steps of arranging the first cardboard sheet on the mandrel and for the final extraction of the piece and disposal of the waste scraps following the final trimming of the ends of the barrel.

Therefore, the processing of such barrels is further slowed down by such manual operations and, obviously, also adversely affects the safety of the operators themselves, who must continuously come into contact with the machine.

Other known solutions involve the use of intermediate buffers between the reel unwinding station and the cutting station, which allow the paper advancement to be slowed or stopped during the cutting phase, while maintaining continuous unwinding of the reel at the feed station.

These systems, therefore, also require a slowing or stopping of the paper advancement and, at the same time, require an intermediate buffer element, to the detriment of machine complexity and productivity.

### SUMMARY OF THE INVENTION

Therefore, the need to provide an improved apparatus for producing frustoconical barrel bodies made of cardboard, capable of overcoming the drawbacks typical of the prior art, is strongly felt.

In particular, an object of the present invention is to provide an apparatus that allows to achieve a higher productivity, a reduced intervention by an operator and a higher quality of the finished piece.

Such a need is satisfied by an apparatus and a method as described and claimed herein.

### BRIEF DESCRIPTION OF THE DRAWINGS

The features and the advantages of the apparatus and of the method of the present disclosure will be evident from the description reported hereinbelow of some preferred embodiments, given by way of a non-limiting example, with reference to the accompanying figures, in which:

FIG. 1 shows an apparatus for producing frustoconical barrel bodies, in an embodiment of the present invention;

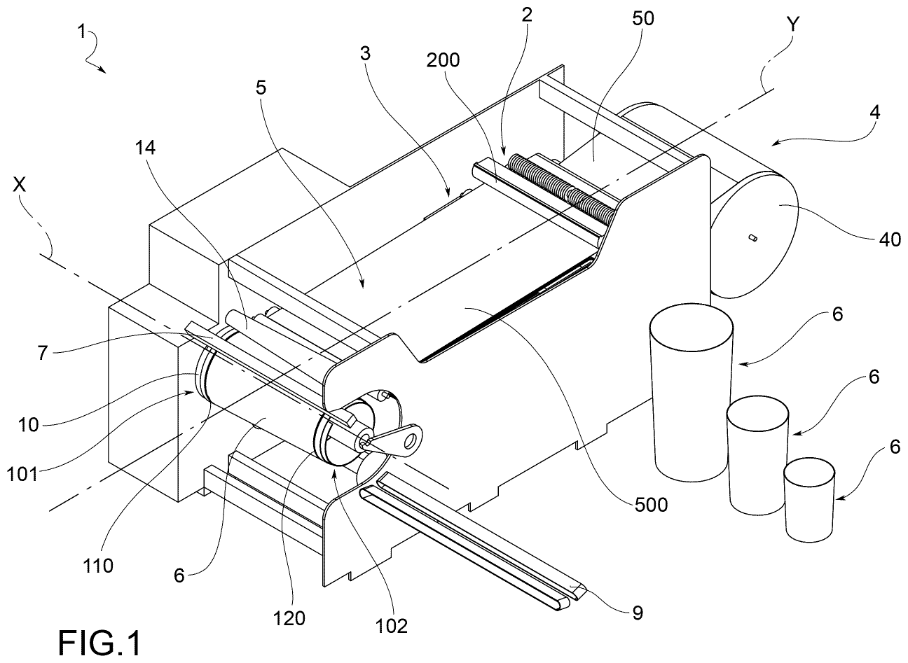

FIG. 2 shows a perspective view of an apparatus according to an embodiment of the present invention, in which some portions of external casing have been removed to allow viewing the internal mechanisms of the machine;

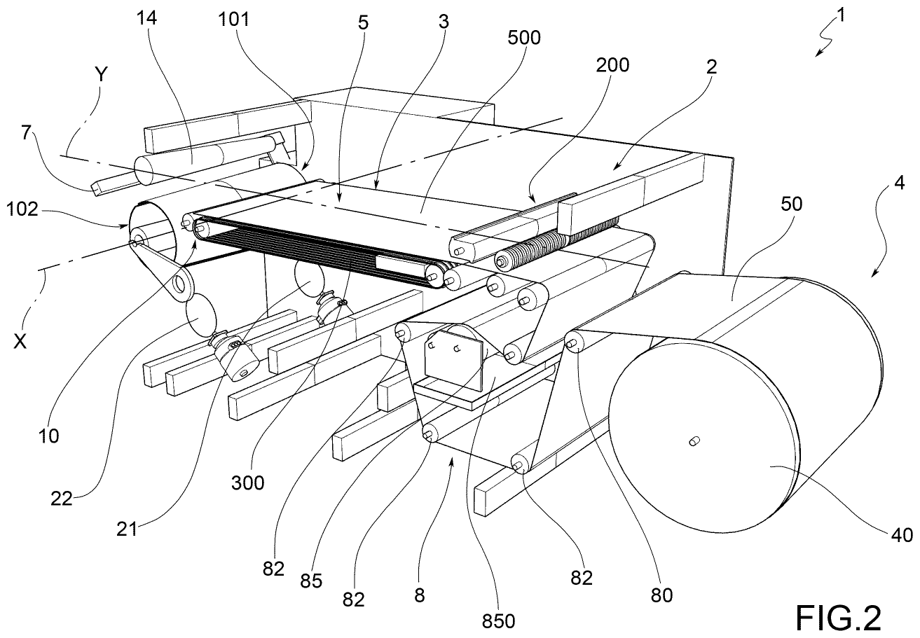

FIG. 3 shows an enlargement of FIG. 2 at a conveyor device, in an embodiment of the present invention;

FIG. 4 shows a side view of the apparatus of FIG. 2;

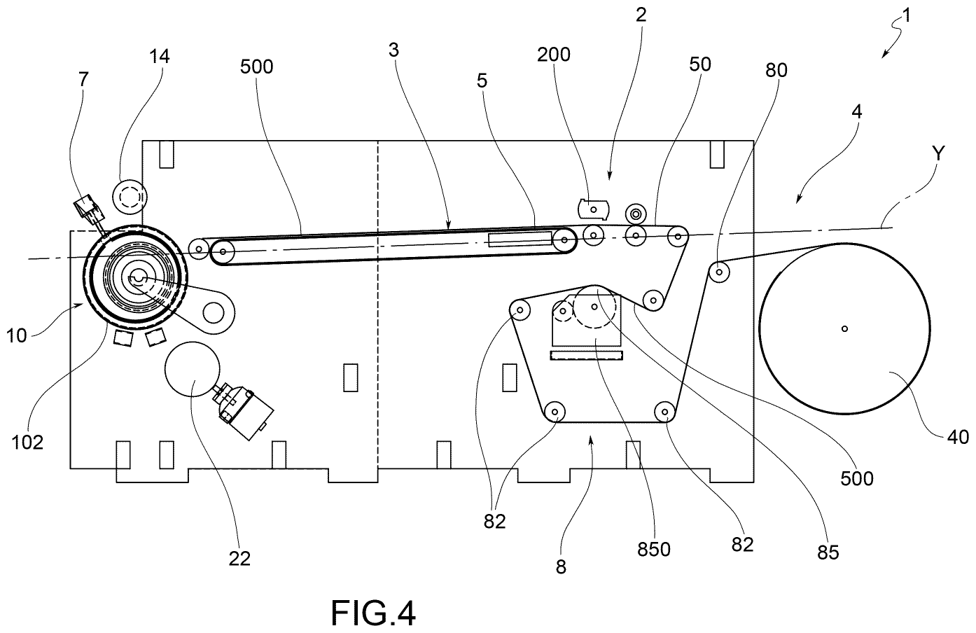

FIG. 5 shows a front view, on the drum side, of an apparatus according to an embodiment of the present invention;

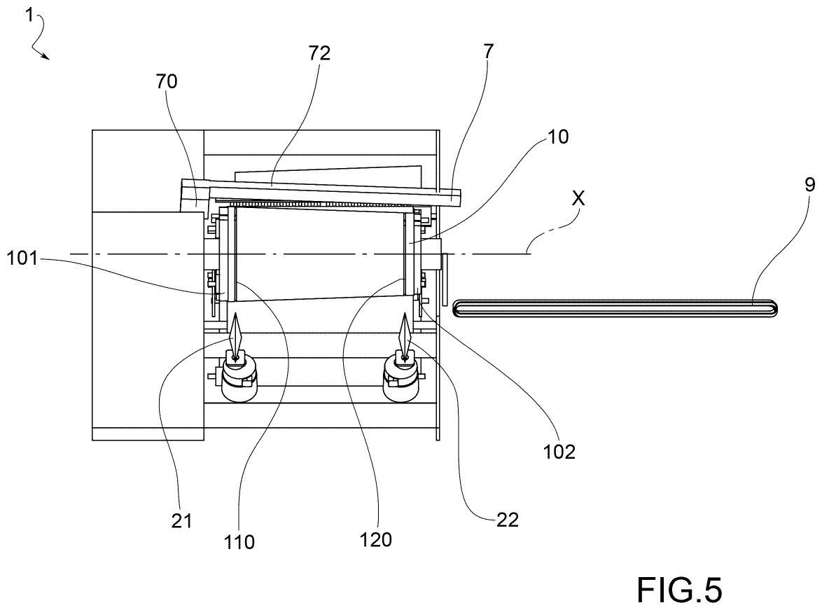

FIG. 6 shows a schematic view of an apparatus for producing frustoconical barrel bodies in an embodiment of the present invention; and

FIG. 7 shows a schematic view of an apparatus for producing frustoconical barrel bodies in an embodiment of the present invention.

### DETAILED DESCRIPTION

With reference to the figures, reference numeral 1 denotes an apparatus for producing frustoconical barrel bodies 6 made of paper, preferably kraft fibre.

In particular, the frustoconical barrels are of considerable dimensions, with a base diameter between 20 and 100 cm and a height between 40 and 200 cm.

Preferably, the frustoconical barrels have a capacity between 5 litres and 250 litres.

With reference to the accompanying figures, the apparatus 1 comprises a substantially frustoconical drum 10 which extends around a rotation axis X and which is rotatably operable around the rotation axis X.

In an embodiment, the drum 10 is delimited by an external surface 100 in which a plurality of through holes are obtained, arranged along a generatrix line substantially parallel to the rotation axis X and coupled to a vacuum source, inside the drum 10, to provide a negative pressure through it, that is, to exert a suction force towards the drum 10 itself.

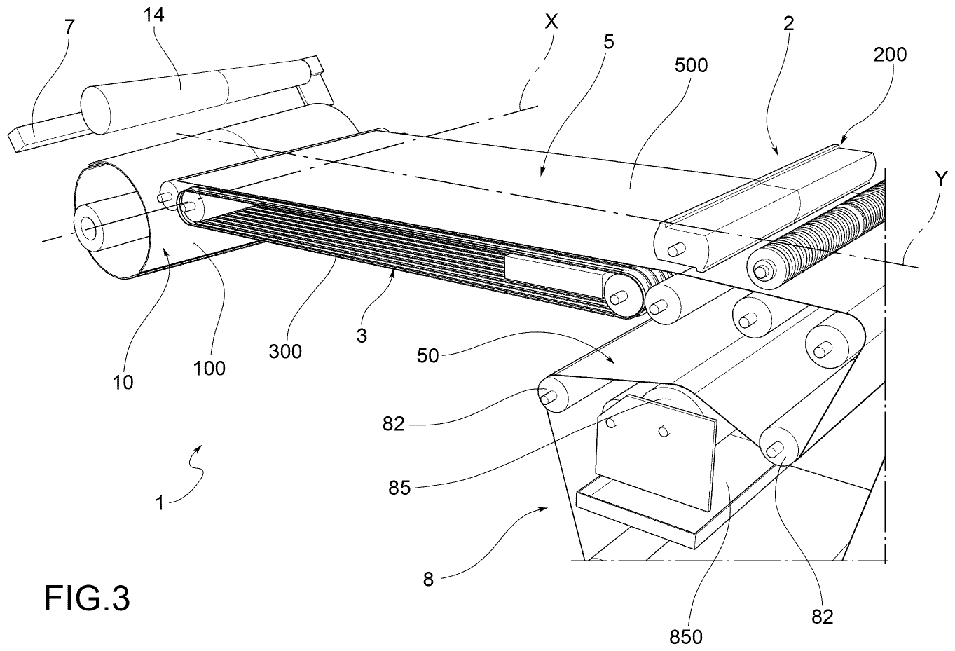

Upstream of the drum 10, the apparatus 1 comprises a conveyor device 3, preferably formed by a plurality of round-section elements 300 suitable for forming a sliding inclined plane, for example as shown in FIG. 3. Such conveyor device 3 is suitable for allowing the sliding of sheets 5 from a feeding station 4 arranged upstream of the apparatus, towards the drum 10.

Preferably, the conveyor device 3 is arranged downstream of the feeding station 4 and upstream of the drum 10 along a sheet feeding direction Y, preferably incident, preferably substantially, orthogonal to the rotation axis X.

In an embodiment, the feeding station 4 comprises a reel 40 on which paper 50 is wound to form a roll.

The feeding station 4 further comprises a pulling assembly 8 suitable for unwinding the paper 50 at a preset unwinding speed vs.

In an embodiment, the pulling assembly 8 comprises a first roller 80 suitable for unwinding the paper 50 from the reel 40 in the sheet feeding direction Y.

In an embodiment, the pulling assembly 8 further comprises a plurality of traction rollers 82 suitable for accompanying the paper unwound from the first roller 80 towards the conveyor device 3 along the sheet feeding direction Y.

In an embodiment, the pulling assembly 8 comprises a gluing system 85.

In an embodiment, the gluing system 85 is interposed between the feeding station 4 and the conveyor device 3, preferably between the reel 40 and the conveyor device 3.

In an embodiment, the gluing system 85 comprises a gluing roller 855 suitable for being wetted with glue by a glue feeding device, for example a tank 850 or a glue dispensing device 851.

The gluing roller 855 is suitable for coating with adhesive material an upper face 500 of the paper 50 dragged by the gluing roller 855 or a sheet 5 following the cutting of the paper 50 into sheets 5.

In an embodiment, the gluing system 85 comprises a gluing roller 855 communicating with a tank 850 containing an adhesive material, preferably liquid. The gluing roller 855 is suitable for rotating by drawing the adhesive material from the tank 850 and, in its rotation around its own axis, preferably parallel to the rotation axis X, transferring it onto the upper face 500 of the unwound paper 50 sliding thereon.

In an embodiment, the gluing system 85 comprises a glue dispensing device, for example a dripping system or a spraying device, suitable for actively wetting the gluing roller 855 by dispensing glue. The gluing roller 855 is wetted directly by the glue dispensing device or indirectly, by contact against a dispensing roller 851 interposed between the glue dispensing device and the gluing roller 85.

According to the present invention, the apparatus 1 comprises a fly cutting device 2 downstream of the feeding station 4 and upstream of the drum 10, preferably upstream of the conveyor device 3.

The fly cutting device 2 is suitable for cutting the paper 50 into successive sheets 5 without stopping or reducing the preset unwinding speed vs, preferably during the sliding of the paper 50 along the sheet feeding direction Y, that is, while the paper 50 is in motion, preferably along the sheet feeding direction Y.

In other words, the cutting takes place on paper that is not undergoing interruptions or slowing down with respect to the unwinding speed vs. This means that not only the reel does continue to unwind, but the paper is in motion right at the cutting station, i.e. at the fly cutting device.

Advantageously, the fly cutting device 2, known in English as “flying cutting knife”, allows to cut the paper 50 during its movement, without stopping the production process, that is, in particular without requiring slowdowns or stoppages of the machine to allow cutting. Advantageously, this makes it possible to optimize the productivity of the apparatus and to reduce downtimes and slowdowns commonly necessary for production on traditional machines.

In an embodiment, the fly cutting device 2 comprises a movable blade 200 and the apparatus 1 comprises an electronic control unit configured to synchronize the movement of the movable blade 200 with the preset unwinding speed vs.

Advantageously, such control allows the movable blade to operate the cutting of the unwound paper avoiding undesired jamming upstream or downstream of the fly cutting device 2.

In an embodiment, the movable blade 200 is a rotating blade, that is, it is a blade mounted on a shaft that rotates at high speed. The shape of the rotating blade may vary (circular, helical or segmented) depending on the type of cutting and the type of paper to be processed.

In an embodiment, the fly cutting device 2 comprises a synchronization system configured to synchronize the rotation speed of the blade with the preset unwinding speed vs, so that the cutting of the paper takes place without interrupting the production flow.

In an embodiment, the fly cutting device 2 comprises an electric or hydraulic motor, suitable for providing the necessary power for rotation. The fly cutting device 2 may further comprise a transmission system comprising belts, gears or chain systems to transmit motion to the movable blade.

The pulling assembly is suitable for keeping the paper 50 in position and ensuring that it is correctly aligned with the blade.

In an embodiment, the fly cutting device 2 is operatively connected with a control unit and with position and speed sensors configured to monitor the movement of the paper and of the movable blade and configured to send data to the control unit which regulates synchronization and ensures that the cutting is precise and uniform.

The operation of the fly cutting device is herein described in an embodiment. The feeding station 4 continuously unwinds paper 50 at an unwinding speed vs towards the cutting device 2. The paper 50 reaches the cutting device 2, in which the rotating blade is already synchronized with the unwinding speed vs by the sensors and the control unit. When the paper 50 reaches the cutting point, the control unit actuates the movable blade 200 which rotates rapidly and cuts the paper on the fly, without stopping the process. After cutting, the blade continues to rotate until the next cutting cycle.

Advantageously, the fly cutting device is provided with a control unit that ensures precise and uniform cuts.

Advantageously, the fly cutting device 2 with rotating blade allows to perform precise cuts on materials in continuous movement, improving efficiency and reducing downtimes in production lines.

In an alternative embodiment, the movable blade 200 is translatable along the sheet feeding direction Y synchronously with respect to the unwinding of paper, that is, at the same preset unwinding speed vs.

In an embodiment, the movable blade 200 is furthermore translatable transversely towards the paper 50 (preferably transversely to the sheet feeding direction Y) to perform the cutting. When it is time to cut, as a function of a command sent by the electronic control unit, the movable blade 200 approaches the paper 50 allowing contact between the movable blade 200 and the paper 50 and consequently the cutting thereof.

While the movable blade 200 and the paper 50 move substantially at the same preset unwinding speed vs along the sheet feeding direction Y, the movable blade 200 translates vertically and performs the cut.

Advantageously, thanks to this synchronized movement, the cutting takes place without stopping the feeding, ensuring a continuous and smooth operation.

After cutting, the movable blade 200 retracts in a transverse direction and parallel to the sheet feeding direction Y, ready for the next cutting cycle. This return takes place rapidly so as to be immediately available at the next cutting interval.

Advantageously, equipping the apparatus 1 with a fly cutting device 2 makes it possible to maintain continuity of production, thus increasing efficiency and reducing downtimes, which, as anticipated in the initial section of the present discussion, in apparatuses for producing frustoconical barrel bodies, are currently extremely considerable.

In an embodiment, the fly cutting device 2 is arranged downstream of the gluing system 85 and upstream of the conveyor device 3. In such embodiment, therefore, the cutting into sheets 5 is performed on paper 50 already coated with glue.

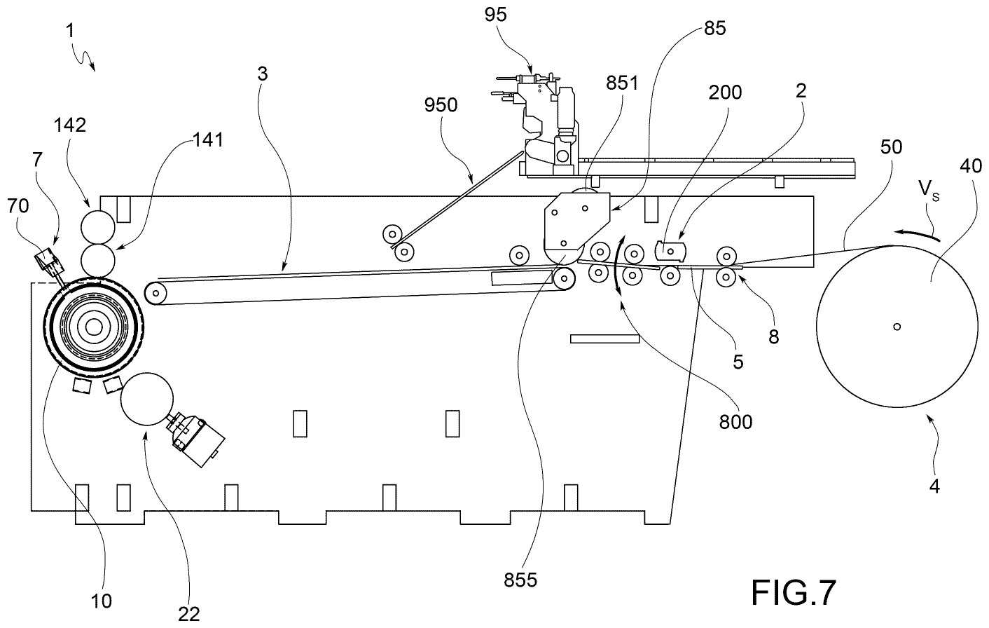

In an embodiment, for example as shown in the schematic example of FIG. 7, the fly cutting device 2 is arranged upstream of the gluing system 85 and downstream of the feeding station 4, preferably downstream of the reel 40. That is, in such advantageous variant, the fly cutting device 2 is arranged upstream of the gluing system 85, that is, the cutting into sheets 5 is performed on dry paper 50.

Advantageously, in such embodiment the problems due to the encounter of the movable blade with the paper wetted with glue are avoided, such as wear and the formation of dried glue residues on the blade, which could affect, cycle after cycle, the quality of the cutting and the general precision of the cutting device.

In an embodiment, between the cutting device 2 and the gluing system 85 the apparatus 1 comprises a series of auxiliary accompanying rollers 800 suitable for accompanying each cut sheet towards the gluing roller 855.

Preferably, the gluing system 85 is arranged close to the conveyor device 3, so that the sheet 5 already cut and coated with glue is directly deposited on the conveyor device 3 to be transported towards the drum 10.

In an embodiment, the electronic control unit is configured to block the deposition of glue by the gluing system 85 on the last sheet 5 of each production cycle of each barrel 6, that is, on the sheet 5 which will result on the external surface of the barrel 6.

For example, the control unit is configured to interpose a shielding device between the last sheet 5 and the gluing roller 855 so that the glue does not reach the last sheet.

According to another example, the control unit is configured to alter the relative position between the gluing roller 85 and the auxiliary accompanying rollers 800 at the passage of the last sheet, so that the last sheet does not come into contact with the gluing roller 855.

Such embodiment is advantageous for the production of barrels that do not provide the application of any label on their lateral surface.

Advantageously, such embodiment allows to limit the waste of glue.

In an embodiment, the apparatus 1 comprises a label feeding device 95 suitable for providing labels to be affixed to the last sheet 5 of each barrel body 6 before such sheet reaches the drum 10, preferably at the conveyor device 3.

In an embodiment, the electronic control unit is configured to actuate the label feeding device 95 to perform the feeding of a label towards the sheet 5 lying on the conveyor device 3 in a synchronized manner with the transport of the sheet 5 towards the drum 10 without stopping the unwinding of paper 50. Preferably, the label feeding device 95 comprises a chute 950 suitable for accompanying each label towards the conveyor device in a manner synchronous with the unwinding speed vs.

As previously anticipated, the drum 10 extends along and around the rotation axis X between a right end 101 and a left end 102.

In an embodiment, at each of the right 101 and left 102 ends of the drum 10, the apparatus 1 comprises cutting devices 21, 22, preferably disc blades, suitable for circumferentially trimming, orthogonally with respect to the rotation axis X, the barrel body 6, once made, wound on the drum 10, at its ends.

In an embodiment, the cutting devices 21, 22 are such as to generate a right waste 61 and a left waste 62 in the form of two paper rings at the ends of the trimmed barrel body 6.

In an alternative embodiment, the cutting devices 21, 22 are laser cutters suitable for circumferentially trimming, orthogonally with respect to the rotation axis X, the barrel body 6, wound on the drum 10, at its ends.

Preferably, the drum 10 is tapered from the right end 101 towards the left end 102.

In an embodiment, the drum 10 comprises, close to the right end 101 and to the left end 102, grooves 110, 120 obtained on the lateral surface thereof.

In an embodiment, the cutting devices, preferably the disc blades 21, 22 are suitable for abutting against the drum 10 at the grooves 110, 120 so that the trimming of the barrel body 6 is further guided, that is, the guided generation of the right waste 61 and of the left waste 62.

Preferably, the grooves 110, 120 are of infinitesimal thickness so as to act as a guide for the trimming but at the same time prevent paper from jamming inside them during trimming.

In an embodiment, the apparatus comprises one or more pressing rollers 14 suitable for being moved in rotation and/or translation to come into contact with the lateral surface 100 of the drum 10, so as to press on it to guide the controlled winding of the paper sheets 5 one on top of the other to form the frustoconical barrel body 6.

Preferably, the one or more pressing rollers 14 are rotatable around their own rotation axis parallel to the rotation axis X of the drum. In a preferred embodiment, the one or more pressing rollers are likewise frustoconical but tapered inversely with respect to the drum 10, so that the lateral surface of the pressing roller always remains parallel to the lateral surface 100 of the drum 10.

In an embodiment, the one or more pressing rollers 14 comprise a primary pressing roller 141 suitable for being pressed onto each glued sheet 5 and a secondary pressing roller 142 suitable for being pressed onto each sheet without glue or onto a possible label.

In an embodiment, the electronic control unit is suitable for actuating the primary pressing roller 141 or the secondary pressing roller 142 depending on whether the sheet to be pressed onto the drum 10 is glued or not. That is, the electronic control unit is configured to receive a glue absence signal generated by a sensor and to actuate the secondary pressing roller 142 as a function of said signal.

In a preferred embodiment, the apparatus 1 comprises an ejector device 7 close to the drum 10, movable along a direction parallel to the surface of the drum 10 and orthogonal to the sheet feeding direction Y, and suitable for ejecting the barrel body 6 produced at the end of processing.

In an embodiment, the ejector device 7 comprises a thrust arm 70 sliding along a rectilinear guide 72. The thrust arm 70 is suitable for coming into contact with the drum 10 close to the right end 101 thereof and for generating a thrust feedback with respect to the barrel body 6, preferably with respect to the related right waste 61, and for pushing the right waste 61, the trimmed barrel body 6 and the left waste 62 along the rotation axis towards the left end 102 of the drum, to perform the ejection of the barrel body 6.

Preferably, the apparatus 1 comprises a collection tray 9 arranged proximal to the drum 10, preferably close to the left end 102, and suitable for receiving the barrel body 6 and optionally the right waste 61 and the left waste 62 expelled by the ejector device 7.

In a preferred embodiment, the drum 10 comprises a collapsing portion suitable for retracting towards the rotation axis X to facilitate the detachment of the barrel body 6 from the lateral surface of the drum 10 to allow its ejection.

In an embodiment, the apparatus 1 comprises a position sensor configured to detect the alignment of a paper sheet on the drum 10 with respect to a predetermined optimal position and to send a misalignment signal to an electronic control unit, to inform the operator of the misalignment of the sheet with respect to the optimal position and possibly interrupt the processing to allow the correct positioning of the paper.

If the sensor does not detect misalignments, the process continues in an automated manner.

In an embodiment, the apparatus 1 comprises positioning devices, for example suction cups, suitable for moving the sheets 5, as a function of a misalignment signal generated by the sensor, so as to reach the optimal position.

In an embodiment, the drum is provided with chamfered edges proximal to its right end 101 and left end 102.

In an embodiment, the apparatus 1 provides for a transverse feeding of the paper 50 from the feeding station 4 with respect to the sheet feeding direction Y, preferably a transverse unwinding of the reel 40 with respect to the sheet feeding direction Y.

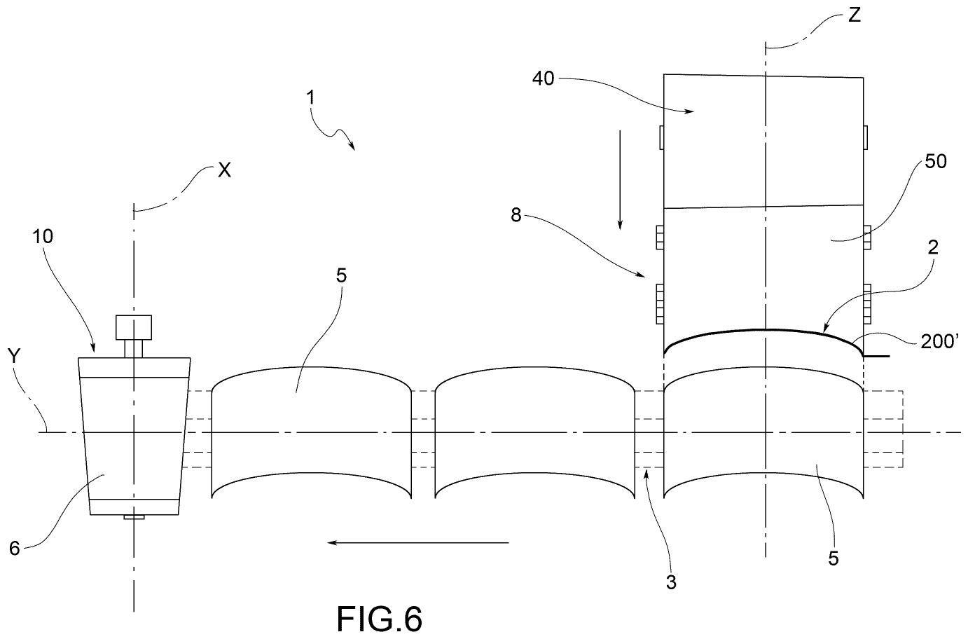

According to such embodiment, schematized in FIG. 6, the reel 40 is arranged perpendicularly with respect to the sheet feeding direction Y and unwinds paper along a starting direction Z substantially orthogonal with respect to the sheet feeding direction Y and preferably parallel with respect to the rotation axis X.

In an embodiment, the apparatus 1 is suitable for performing the cutting of sheets already having the final shape suitable for making the barrel body so as not to produce waste.

In a preferred embodiment, the fly cutting device 2 comprises a shaped blade 200′ suitable for cutting the paper 50 to obtain sheets 5 having a suitable shape, once wound on the drum 10, for making the barrel body 6 avoiding the generation of waste.

In an embodiment, the fly cutting device 2 is suitable for making a sort of “paper pattern” of the barrel body 6.

In an embodiment, the fly cutting device 2 performs the cutting of the sheets 5 perpendicularly with respect to the starting direction Z, that is, it cuts the sheets along the parts which subsequently, in winding, will form the edges of the upper and lower bases of the barrel body, which will later receive the lid and the bottom of the frustoconical barrel.

In an embodiment, the shaped blade 200′ has a curved shape, and in particular has an arc-of-a-circle generatrix, of a circumference having a radius between 4 and 8 metres, preferably between 5 and 7 metres, more preferably equal to about 6 metres.

The operation of the apparatus 1 for the formation of a frustoconical barrel body 6 in an embodiment of the apparatus 1 will now be described.

For the formation of a frustoconical barrel body 6, the first roller 80 generates the unwinding of the paper 50 from the reel 40 and the plurality of traction rollers 82 accompany the unwinding of the paper 50 in a sheet feeding direction Y towards the drum 10.

A gluing roller 855 releases adhesive material on a surface 500 of the unwound paper 50.

A fly cutting device 2 performs the cutting of the paper 50 unwound by the pulling assembly 8 into a successive series of sheets 5 having the surface 500 coated with adhesive facing upwards, all during the continuous feeding from the feeding station 4 without interruptions or slowdowns.

The paper sheets 5 are fed along the sheet feeding direction Y to the conveyor device 3 and are accompanied by it towards the drum 10.

A predetermined number of successive paper sheets 5, preferably seven or eight, are brought to the drum 10. The first sheet 5 of the paper sheets 5 reaches the drum 10 at the suction holes and is arranged on the surface of the drum 10 while the latter is rotated around the rotation axis X.

The first sheet 5 is followed by the winding of the subsequent sheets 5 until the predetermined number is reached, one on top of the other, until the complete winding of the barrel body 6.

Preferably the last sheet is covered with a label provided by the label feeding device 95 or the dispensing of glue onto it is blocked.

At the end of this operational sequence, the disc blades 21, 22 perform the trimming of the barrel body 6 at the ends of the drum 10 to separate the barrel body 6 from the right and left wastes and to regularize the edges of the barrel body 6 which will subsequently be processed to serve as the edge of the upper base (opening edge) and the edge of the lower base (bottom edge) of the finished frustoconical barrel.

Finally, the ejector device 7 is actuated along a direction parallel to the surface of the drum 10 and orthogonal to the sheet feeding direction Y to eject the barrel body 6 towards a collection tray 9 situated close to the apparatus.

Also forming the subject-matter of the present invention is a method for producing a barrel body 6 made of paper starting from paper 50 preferably wound on a roll, comprising the following steps:
a) providing an apparatus 1 according to the present invention;
b) by means of the pulling assembly 8, unwinding paper 50 from the feeding station 4 towards the drum 10, at an unwinding speed vs;
c) by means of the fly cutting device 2, cutting the paper 50 unwound by the pulling assembly 8 into successive sheets 5 during the continuous feeding of the paper, without interruptions or slowdowns with respect to the unwinding speed vs;
d) by means of the conveyor device 3, transporting a number of successive sheets 5 to the drum 10 rotating around the rotation axis X and winding them one on top of the other until the formation of a barrel body 6.

In an embodiment, step c) comprises the following sub-steps:
c1) by means of the electronic control unit, synchronizing the actuation of the fly cutting device 2 with the preset speed; and
c2) performing the cutting of the paper 50 while unwinding the paper at the preset speed, without interrupting the unwinding or slowing down the preset speed.

In an embodiment, wherein the apparatus 1 comprises:
cutting devices 21, 22 positioned at a right end 101 and a left end 102 of the drum 10;
an ejector device 7 close to the drum 10, movable along a direction parallel to the surface of the drum 10; and
the method comprises, following step d), the following finishing and ejection steps:
by means of the cutting devices 21, 22, circumferentially trimming, at its ends, the barrel body 6 wound on the drum 10;
by means of an ejector device 7, ejecting the barrel body 6 at the end of the processing, pushing it towards a collection tray 9.

According to an embodiment, the method further comprises a gluing step, before or after the cutting step into sheets, as described previously.

Innovatively, the present invention solves the drawbacks of apparatuses for producing frustoconical barrels typical of the known art.

Advantageously, the apparatus according to the present invention ensures a significant reduction in production times and a consequent substantial increase in the production rate.

According to a further advantage, in a particularly efficient embodiment, the fly cutting device and the ejector device contribute synergistically to optimizing the production process, making the entire machine cycle more effective and efficient. In fact, the Applicant has verified that by means of the application of such devices, the making of a barrel body provides for the winding of one sheet for each rotation of the drum. This proves to be extremely advantageous compared with what currently occurs, wherein present machines require a plurality of drum rotations for the winding of each sheet.

Advantageously, therefore, the apparatus according to the present invention also allows a considerable saving of energy for the electric actuation of the drum itself.

According to a further advantage, the position sensor further speeds up the production times of the apparatus while also optimizing the quality of the finished product.

Advantageously, the drum provided with chamfered edges is more ergonomic and avoids troublesome encumbrances with respect to the other components, for example with respect to the ejector device.

According to a further advantage, in addition to a saving in production times, the apparatus of the present invention also benefits from a saving regarding excess paper, optimizing the positioning and the feeding of the sheets to be wound on the drum.

Advantageously, in the embodiment which provides for a starting direction orthogonal with respect to the sheet feeding direction and the pre-cutting of sheets already having the final shape suitable for making the barrel without waste, the process is further optimized, since the elimination of final wastes is achieved, that is, the need to trim the barrel body is avoided, and at the same time the time of such processing is saved.

That is, such embodiment makes it possible to absorb into a single cutting operation, upstream of the winding, also the final trimming, no longer necessary.

The Applicant emphasizes that in evaluating the innovations introduced by the present invention it would not be correct to consider the apparatuses for producing cylindrical barrel bodies. This is because the method of producing frustoconical barrel bodies, even with very slight conicity, encounters practical process obstacles, such as the need to separate the unwinding of paper into a series of successive sheets, approximately from 5 to 10, to handle the lateral surfaces of the barrel body still soft due to the presence of adhesive material, the processing on surfaces not aligned with the rotation axis of the drum, or the need to carry out the cutting of production waste, which do not arise in the manufacture of cylindrical barrel bodies.

Such process obstacles are clearly to be considered as hindrances in innovating a machine and, in the state of the art, there has never been a way to revolutionize existing machines while also facing and solving such drawbacks.

The present invention is the result of long process analyses and studies aimed at minimizing machine downtimes and increasing productivity.

It is clear that, to the embodiments of the aforesaid apparatus, a person skilled in the art, in order to meet specific needs, may make variants or replace elements with other functionally equivalent ones.

Such variants are also contained within the scope of protection as defined by the following claims. Furthermore, each variant described as belonging to a possible embodiment is feasible independently of the other variants described.

What is claimed is:

1. An apparatus for producing a frustoconical barrel body made of paper, the apparatus comprising:
a feeding station comprising a pulling assembly suitable for unwinding paper at a preset unwinding speed;
a substantially frustoconical drum extending about a rotation axis and rotationally operable about the rotation axis; and
a conveyor device arranged downstream of the feeding station and upstream of the substantially frustoconical drum, the conveyor device being suitable for allowing paper sheets to slide from the feeding station towards the substantially frustoconical drum,
wherein the apparatus further comprises a fly cutting device upstream of the substantially frustoconical drum and downstream of the feeding station, the fly cutting device being suitable for cutting the paper into successive paper sheets without stopping or reducing the preset unwinding speed.

2. The apparatus of claim 1, wherein the fly cutting device comprises a movable blade, and wherein the apparatus further comprises an electronic control unit configured to synchronize a movement of the movable blade with the preset unwinding speed.

3. The apparatus of claim 2, wherein the pulling assembly unwinds the paper from the feeding station towards the substantially frustoconical drum along a sheet feeding direction,
wherein the movable blade is movable along the sheet feeding direction synchronously with respect to the paper, at the preset unwinding speed, and
wherein the movable blade is translatable transversely to the sheet feeding direction towards an unwinding of the paper as a function of a command generated by the electronic control unit, to cut the paper into the successive paper sheets.

4. The apparatus of claim 1, wherein the substantially frustoconical drum extends along and about the rotation axis between a right end and a left end, wherein at the right and left ends of the substantially frustoconical drum, the apparatus comprises cutting devices, suitable for circumferentially trimming, at ends thereof, the barrel body wound on the substantially frustoconical drum, orthogonally to the rotation axis,
wherein the substantially frustoconical drum comprises, close to the right end and the left end, grooves obtained on a side surface thereof, and
wherein the cutting devices are disc blades suitable for cutting against the substantially frustoconical drum at the grooves so that a trimming of the barrel body is further guided.

5. The apparatus of claim 4, wherein the grooves are of an infinitesimal thickness so as to prevent the paper from jamming therein during the trimming.

6. The apparatus of preceding claim 1, further comprising an ejector device close to the substantially frustoconical drum, movable along a direction parallel to a surface of the substantially frustoconical drum and suitable for ejecting the barrel body at the end of processing.

7. The apparatus of claim 6, wherein the ejector device comprises a thrust arm sliding along a rectilinear guide, the thrust arm being suitable for coming into contact with the substantially frustoconical drum proximally to a right end of the substantially frustoconical drum and generating a thrust feedback with respect to the barrel body and pushing the barrel body towards a left end of the substantially frustoconical drum, to eject the barrel body.

8. The apparatus of claim 1, further comprising a position sensor configured to detect an alignment of a paper sheet on the substantially frustoconical drum with respect to an optimal position and send a misalignment signal to an electronic control unit, to inform an operator on the misalignment of the paper sheet with respect to the optimal position and optionally stop processing to allow moving the paper to the optimal position.

9. The apparatus of claim 8, further comprising positioning devices, optionally the positioning devices being suction cups, suitable for moving the paper sheet to the optimal position, as a function of the misalignment signal generated by the position sensor.

10. The apparatus of claim 1, further comprising a gluing system interposed between the feeding station and the conveyor device, wherein the fly cutting device is arranged upstream of the gluing system and downstream of the feeding station.

11. The apparatus of claim 1, further comprising a label feeding device suitable for providing labels to be affixed onto a last paper sheet of each barrel body before the last paper sheet reaches the substantially frustoconical drum, preferably at the conveyor device, and wherein the apparatus still further comprises an electronic control unit configured to actuate the label feeding device to feed a label towards the paper sheet lying on the conveyor device in a synchronized manner with a transport of the paper sheet towards the substantially frustoconical drum without stopping an unwinding of the paper.

12. The apparatus of claim 1, wherein the fly cutting device comprises a shaped blade suitable for cutting the paper to obtain paper sheets having a suitable shape, once wound on the substantially frustoconical drum, for making the barrel body avoiding formation of waste, and wherein the fly cutting device cuts the paper sheets perpendicularly to the rotation axis.

13. The apparatus of claim 12, wherein the shaped blade is curved and has an arc-of-a-circle generatrix of a circumference having a radius between 4 and 8 meters.

14. A method for producing a barrel body made of paper starting from paper, optionally wound on a roll, the method comprising the following steps:
a) providing an apparatus comprising:
a feeding station comprising a pulling assembly suitable for unwinding paper at a preset unwinding speed;
a substantially frustoconical drum extending about a rotation axis and rotationally operable about the rotation axis; and
a conveyor device arranged downstream of the feeding station and upstream of the substantially frustoconical drum, the conveyor device being suitable for allowing paper sheets to slide from the feeding station towards the substantially frustoconical drum,
wherein the apparatus further comprises a fly cutting device upstream of the substantially frustoconical drum and downstream of the feeding station, the fly cutting device being suitable for cutting the paper into successive paper sheets without stopping or reducing the preset unwinding speed;
b) by the pulling assembly, unwinding the paper from the feeding station towards the substantially frustoconical drum, at the preset unwinding speed;
c) by the fly cutting device, cutting the paper unwound by the pulling assembly into the successive paper sheets while continuously feeding the paper, without interruptions or slowing down with respect to the preset unwinding speed; and
d) by the conveyor device, transporting a number of the successive paper sheets to the substantially frustoconical drum rotating about the rotation axis and winding the successive paper sheets, one on top of the other, until the barrel body is formed.

15. The method of claim 14, wherein the apparatus further comprises an electronic control unit configured to move the fly cutting device as a function of the preset unwinding speed, and wherein
step c) comprises the following sub-steps:
c1) by the electronic control unit, synchronizing an actuation of the fly cutting device with the preset unwinding speed; and
c2) cutting the paper while unwinding the paper at the preset unwinding speed, without interrupting the unwinding or slowing down the preset unwinding speed.

16. The method of claim 14, wherein the apparatus further comprises:
cutting devices positioned at a right end and a left end of the substantially frustoconical drum;
an ejector device close to the substantially frustoconical drum, movable along a direction parallel to a surface of the substantially frustoconical drum; and wherein
the method comprises, after step d), the following finishing and ejection steps:
by the cutting devices circumferentially trimming, at ends thereof, the barrel body wound on the substantially frustoconical drum; and
by the ejector device ejecting the barrel body at the end of processing, pushing the barrel body towards a collection tray.

17. The apparatus of claim 13, wherein the circumference has a radius ranging between 5 and 7 meters.

18. The apparatus of claim 13, wherein the circumference has a radius equal to 6 meters.
